(19) United States
(12) Patent Application Publication
(10) Pub. No.: US 2007/0033250 A1
(43) Pub. Date: Feb. 8, 2007

(54) Real-time conversation thread

(75) Inventors: Danny Levin, Redmond, WA (US); Amritansh Raghav, Seattle, WA (US); Eran Shtiegman, Redmond, WA (US); Parag Samdadiya, Bellevue, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/195,375

(22) Filed: Aug. 2, 2005

(51) Int. Cl. G06F 15/16

(52) U.S. Cl. 709/204

(57) ABSTRACT

Techniques for managing the continuity of real-time conversations are provided. Some techniques allow a participant to restore a conversation that previously occurred and has ended, and continue a thread of the conversation by reusing history data associated with the conversation and appending new data. A participant who is invited to a conversation that is being continued is provided with the history data or provided access to the history data, thus allowing the invited participant to “catch up” in the conversation. The invited participant may also continue the thread in a similar manner afterwards.

### BACKGROUND

Users of computing devices (e.g., laptops, cellular phones, and personal digital assistants) often need to communicate in real time. A common form of real-time communications is provided by instant messaging services. An instant messaging service allows a participant at an endpoint to send messages and have them received within a second or two by the other participant in a conversation. The receiving participant can then send responsive messages to the other participant in a similar manner.

To support real-time communications, communications applications typically need to establish and manage connections (also referred to as sessions or dialogs) between computing devices. A session is a set of interactions between computing devices that occurs over a period of time. As an example, instant messaging services require a networking protocol to establish and manage communications between participants. These services may use various mechanisms to establish sessions, such as a “Session Initiation Protocol” (“SIP”). SIP is an application-level control protocol that computing devices can use to discover one another and to establish, modify, and terminate sessions between computing devices. SIP is a proposed Internet standard. The SIP specification, “RFC 3261,” is available at <http://www.ietf.org/rfc/rfc3261.txt>.

A SIP network comprises entities that can participate in a dialog as an endpoint, server, or both. SIP supports four types of entities: user agent, proxy server, redirect server, and registrar. User agents initiate and terminate sessions by exchanging messages with other SIP entities. A user agent can be a user agent client, which is generally a computer system that initiates SIP requests, or a user agent server, which is a computer system that generally receives SIP requests and responds to such requests. As examples, “IP-telephones,” personal digital assistants, and various other types of computing systems may be user agents. A computer system can be a user agent client in one dialog and a user agent server in another, or may change roles during the dialog. A proxy server is an entity that acts as a server to clients and a client to servers. In so doing, proxy servers intercept, interpret, or forward messages between clients and servers. A redirect server accepts a SIP request and generates a response directing the client that sent the request to contact an alternate network resource. A registrar is a server that accepts registration information from SIP clients and informs a location service of the received registration information.

SIP supports two message types: requests, which are sent from a client to a server, and responses, which are sent from a server to a client, generally when responding to a request. A SIP message is comprised of three parts. The first part of a SIP message is a “start line,” which includes fields to indicate a message type and a protocol version. The second part of a SIP message comprises header fields whose values are represented as name-value pairs. The third part of a SIP message is the message's body, which is used to describe the session to be initiated or contain data that relates to the session. Message bodies may appear in requests or responses.

To start a conversation, an inviting participant typically sends an invitation from an endpoint to the instant messaging service, which then forwards the invitation to an endpoint for the receiving participant. The invitation can take place using the SIP INVITE protocol. The endpoint for the receiving participant then accepts the invitation, forming a conversation between the two participants which is typically represented as a conversation window at each participant's instant messaging endpoint. The participants can then each type messages back and forth to each other until the conversation is terminated by either of the participants by, for example, closing the conversation window.

It is becoming increasingly common for multiple participants to be involved in a conversation. For example, today's businesses often assign business projects to work groups with members physically located in disparate locations, and these members need to be involved in the same conversation. However, because typical instant messaging services rely on a point-to-point protocol, such as SIP, a conversation is limited to the two participants who are engaged in an instant messaging session. If another, third participant who wants to join the existing conversation establishes an instant messaging session with either one of the two participants who are currently engaged in the existing conversation, typical instant messaging services do not provide a mechanism for indicating or associating the newly created instant messaging session with the existing conversation. Rather, two distinct conversations, each involving two of the three participants, are created.

Another difficulty with real-time communications is the inability to recall or continue real-time communications that have previously occurred. For example, when an instant messaging session between two participants ends, neither participant is able to continue the instant messaging session at a later time. If the participants were to establish another instant messaging session at a later time in order to continue their discussion from their previous instant messaging session, typical instant messaging services do not make the content from the previous instant messaging session readily available to either of the participants. Thus, the participants are left to resort to their memory to recall what was discussed during the previous instant messaging session. This problem is further compounded in the instance where one of the participants of the previous instant messaging session wants to establish a real-time communication, such as an instant messaging session, audio/video session, etc., with a third participant to continue the topic discussed in the participant's previous instant messaging discussion. In this instance, while the participant from the previous instant messaging session may be able to recall the discussion from his or her memory, the third participant is not able to do so because the third participant did not participate in the previous real-time communication.

### SUMMARY

Techniques for managing the continuity of real-time conversations are provided. Some techniques allow a participant to restore a conversation that previously occurred and has ended, and continue a thread of the conversation by reusing history data associated with the conversation and appending new data. A participant who is invited to a conversation that is being continued is provided with the history data or provided access to the history data, thus allowing the invited participant to “catch up” in the conversation. The invited participant may also continue the thread in a similar manner afterwards.

The summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a high-level block diagram showing an environment in which the logical conversations may operate.

FIG. 2 is a block diagram illustrating selected components of a client, according to some embodiments.

FIG. 3 illustrates an example SIP INVITE request that includes a conversation identifier, according to some embodiments.

FIG. 4 is a diagram illustrating interactions between clients in sharing a conversation identifier across multiple real-time sessions without a centralized control, according to some embodiments.

FIG. 5 is a flow diagram illustrating the sending of a conversation identifier between two clients, according to some embodiments.

FIG. 6 is a diagram illustrating a plurality of conversation threads, according to some embodiments.

FIG. 7 is a block diagram illustrating metadata associated with a conversation thread instance, according to some embodiments.

FIG. 8 is a diagram illustrating the generation of the conversation thread list of an example conversation thread, according to some embodiments.

FIG. 9 is a flow diagram illustrating the processing of a client application when a user requests to create a session, according to some embodiments.

FIG. 10 is a flow diagram illustrating the processing of a client application to create a next conversation thread instance, according to some embodiments.

### DETAILED DESCRIPTION

Various techniques for associating one or more real-time sessions, which are each signaled separately, into one logical conversation without a centralized control, are provided. The described techniques share a unique conversation identifier that identifies a logical conversation across one or more real-time sessions that belong to the same logical conversation. As used herein, the terms “logical conversation” or “conversation” are used interchangeably and generally refer to one or more real-time sessions, where each session is between participants at two endpoints or user agents.

In some embodiments, a calling participant (e.g., a human user) may execute a client application on his or her client computing system and request to establish a real-time communication service session with a called participant. Upon receiving this request from the calling participant, the client application determines whether it is an initiator of a logical conversation. For example, the client application may determine that it is an initiator of a logical conversation if the requested real-time session is the first session that is created in the logical conversation at the client. In some embodiments, the client application may determine that it is an initiator of a logical conversation if the requested real-time session is the first session that is being created by this particular instance of the client application executing on the client. If the client application determines that it is the initiator of the logical conversation, the client application generates a unique conversation identifier for the logical conversation, and sends the unique conversation identifier along with a request to the called participant to establish or create the real-time session. In some embodiments, the client application may associate the real-time session to the logical conversation after establishing the real-time session. For example, the client application may create a record in a database that identifies the logical conversation and the created real-time session.

If the client application determines that it is not the initiator of the logical conversation (i.e., the requested real-time session is not the first session that is created in the logical conversation), the client application identifies an existing logical conversation and the existing conversation identifier that uniquely identifies the existing logical conversation. The client application then sends the existing conversation identifier along with a request to the called participant to establish or create the real-time session. In some embodiments, the client application may associate the real-time session to the existing logical conversation after establishing the real-time session. Since the existing logical conversation already contained one or more prior real-time sessions on the client (i.e., one or more prior real-time sessions are associated with the existing logical conversation), associating the newly created real-time session to the existing logical conversation in effect associates the prior real-time sessions and the newly created real-time session to each other and to the same logical conversation on the client.

At the called participant's client, upon receiving the request to create the real-time session, the client application determines whether the conversation identifier that was received with the request identifies a logical conversation that is currently active on the client. If the received conversation identifier identifies a logical conversation that is currently active on the client, the client application associates the received request to create the real-time session to the currently active logical conversation identified by the received conversation identifier.

Conversely, if the received conversation identifier does not identify (e.g., does not match) a logical conversation that is currently active on the client, the client application creates a new logical conversation on the client. The client application may identify the newly created logical conversation using the received conversation identifier. The client application associates the received request to create the real-time session to the newly created logical conversation.

In some embodiments, the client application may decide if a new session is part of an existing logical conversation after establishing the session and querying about other existing logical conversations on the remote side (i.e., remote client).

In some embodiments, the client application may decide that a new session belongs to an existing logical conversation based on proximity of new session creation times with other sessions.

In some embodiments, the request to establish the real-time session may be signaled using an application protocol such as SIP or any of a variety of well-known application protocols suitable for establishing the real-time session between the two participants, and the unique conversation identifier may be included as part of the application protocol. For example, the unique conversation identifier may be included in the header of a SIP message. In some embodiments, the unique conversation identifier may be sent separate or apart from the message requesting the establishment of the real-time session.

In some embodiments, the ability to manage the continuity of real-time conversations is provided. For example, a client application may allow a participant to restore a conversation that previously occurred and has ended, and continue a “thread” (i.e., a thread of the conversation that has ended) by reusing history data from the conversation (i.e., data associated with the conversation being continued) and appending new data. A participant who is invited to a conversation that is being continued is provided with the history data or provided access to the history data, thus allowing the invited participant to “catch up” in the conversation. The invited participant may also continue the thread in a similar manner afterwards.

When a conversation is first created or constructed, the created conversation is a conversation thread even if the conversation has not been continued. A conversation thread instance is an instance of a conversation thread, and a conversation thread instance is created each time a new conversation thread is constructed or each time an existing conversation thread is continued.

Thus, a conversation thread is comprised of a path of one or more conversation thread instances. Moreover, a conversation thread can be “forked” or “branched” into one or a multiple conversation threads at any conversation thread instance in the conversation thread as a result of continuations which happen simultaneously by multiple participants. The conversation thread instance may be considered to be active as long as a real-time session that is associated with the conversation thread instance is in a connected state. For example, the conversation thread instance may be considered to be active as long as a SIP dialog of a session is in a connected state—i.e., a BYE has not been sent yet.

In some embodiments, a conversation thread instance is uniquely identified by a conversation thread instance identifier. For example, when a client application first initiates or creates a conversation and, thus, constructs a conversation thread instance for the created conversation, the client application constructs a conversation thread instance identifier that uniquely identifies the conversation thread instance. In some embodiments, the conversation thread instance identifier is comprised of a conversation identifier, which uniquely identifies the conversation, and a conversation thread list, which is a list of participant identifier and timestamp pairs. The participant identifiers in the list identify the participants who initially originated the conversation thread and the any participants who continued the conversation thread thus far (i.e., up to the present conversation thread instance), and the corresponding timestamps indicate when each of the participants originated or continued the conversation thread. In some embodiments, the participant identifier may be the SIP Uniform Resource Indicator (URI) of the participant, and the timestamp may indicate a time when the conversation thread instance was established.

When a client application first constructs a conversation and, thus, a conversation thread instance, the client application generates a unique conversation identifier that uniquely identifies the conversation and sets the conversation thread list with the identifier of the participant who requested the conversation and the time that the participant made the request. The conversation thread instance history (i.e., the history or context of the conversation thread up to the conversation thread instance), such as, by way of example, a roster of participants who participated in the conversation thread, the real-time session modes that occurred in the conversation thread, the content that was communicated in the conversation thread, or other history data associated with the conversation thread, or any combination thereof, may be maintained with the conversation thread instance. In some embodiments, the context of the conversation thread may be maintained in a file or a document, such as an XML document or other suitable document.

Subsequently, this participant or another participant having knowledge of, and access to, the conversation thread may continue the conversation thread from any conversation thread instance in the conversation thread. If a participant continues the conversation thread from an indicated conversation thread instance, the participant's client application obtains a copy of the indicated conversation thread instance and updates the conversation thread list to include an identifier of the participant continuing the conversation thread, and a time that the conversation thread is being continued. In this manner, the combination of the conversation identifier from the indicated conversation thread instance and the updated conversation thread list creates a unique conversation thread instance identifier that may be used to uniquely identify a conversation thread instance associated with the continued conversation thread (i.e., the next conversation thread instance that sequentially follows the indicated conversation thread instance in the conversation thread). The client application may also update the conversation thread instance history associated with the indicated conversation instance thread. For example, the client application may update the roster list, indicate the session or sessions that is being created to continue the conversation thread, and the like. The client application may then send the conversation thread instance (i.e., the conversation thread instance identifier and the conversation thread instance history) that continues the conversation thread to a called participant along with a request to establish or create a real-time session. The requested real-time session is the vehicle that is being used by the participant to continue the conversation thread. In some embodiments, the conversation thread instance history sent to the called participant may be dependent on a policy that is specified or defined by, for example, the participant and/or an administrator. In some embodiments, conversation thread instance identifier may comprise one or more other identifiers, such as, by way of example, a MAC address, a checksum, or other unique identifier, in addition to or in lieu of the participant identifier and/or the timestamp, as long as the conversation thread instance identifier uniquely identifies the conversation thread instance.

In some embodiments, the called participant's client application receives the conversation tread instance and processes the conversation thread instance history. Upon establishing the requested session, the client application may present the conversation thread instance history to the called participant. This allows the called participant to continue the conversation thread from any desired conversation thread instance in the conversation thread.

In some embodiments, the conversation thread instances may be persistently stored on one or more servers that are accessible by the participants and, in particular, the participants' client applications. For example, when a participant invokes and instance of the client application on his or her client, the client application may retrieve from the appropriate server or servers the conversation thread instances belonging to the participant. The client application may then display, for example, on a user interface the retrieved conversation thread instances or a subset of the conversation thread instances to the participant. In some embodiments, the conversation thread instances may be persistently stored in a distributed manner on a number of clients and/or servers.

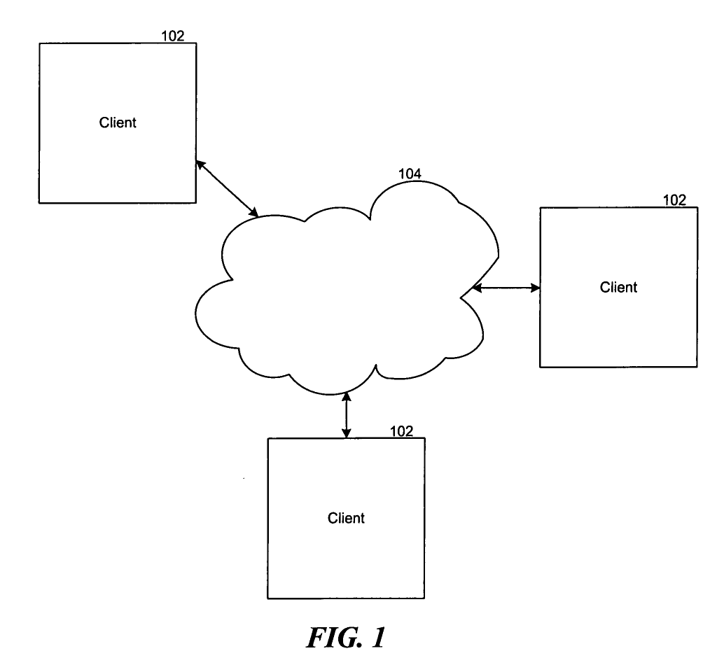

FIG. 1 is a high-level block diagram showing an environment in which the logical conversations may operate. As depicted, the environment comprises a plurality of client computing systems 102 each coupled to a network 104. In general terms, each client computing system allows a user, such as a human user, to participate in one or more logical conversations. For example, a user at one of the clients may at act as a calling participant and use the client and, in particular, an application program executing on the client to request a real-time session with a called participant, for example, at another client computing system. If the real-time session is the first session in a logical conversation, the calling participant's client generates a conversation identifier that uniquely identifies the logical conversation. In this instance, the calling participant's client is originating the logical conversation. If the real-time session is not the first session, the calling participant's client determines the conversation identifier of an existing logical conversation (i.e., the conversation identifier that uniquely identifies the existing logical conversation). For example, the calling participant may already be participating in one or more logical conversations with one or more other participants, and may have requested the real-time session with the called participant within one of the logical conversations. In this instance, the calling participant's client is extending the existing logical conversation within which the calling participant made the request to include the requested real-time session.

The calling participant's client sends the called participant's client the request to establish a real-time session and the conversation identifier. Upon establishing the real-time session with the called participant, the calling participant's client associates the newly created real-time session to the conversation identifier. In this manner, the newly created real-time session becomes either, the first session in the logical conversation (e.g., in the case that the calling participant's client initiated the logical conversation), or associated with the other real-time sessions that already belong to the existing logical conversation (e.g., in the case that the calling participant's request was made within an already existing logical conversation).

The called participant's client receives the request to establish a real-time session and the conversation identifier, and attempts to match the conversation identifier to all the logical conversations that are active on the client. If a match is found, the called participant's client associates the request to establish the real-time session to the logical conversation that is active on the client (e.g., the logical conversation running on the client that is identified by the conversation identifier). Otherwise, if no match is found (i.e., there are no logical conversations running on the client or none of the logical conversations running on the client are identified by the conversation identifier), the called participant's client creates a new logical conversation and associates the request to establish the real-time session to the newly created logical conversation. Having associated the request to establish the real-time session to either a currently running logical conversation or a newly created logical conversation, in some embodiments, the client may provide the called participant an indication of the received request to establish the real-time session. For example, if a currently running logical conversation was found on the client, the client may provide the indication of the received request within the user interface for the currently running logical conversation. Otherwise, if a new logical conversation was created on the client, the client may provide the indication of the received request within a user interface created for the newly created logical conversation.

The called participant may then accept the requested real-time session with the calling participant. Upon establishing the real-time session with the calling participant, the called participant's client associates the newly created real-time session to the conversation identifier received from the calling participant. In this manner, the newly created real-time session becomes either, a first session in the logical conversation (e.g., in the case that the called participant's client created the logical conversation), or associated with the other real-time sessions that already belong to the currently running logical conversation (e.g., in the case that the called participant's client successfully matched the received conversation identifier to the logical conversation running on the client).

The calling participant may then establish one or more other real-time sessions with the called participant or one or more other participants within the same logical conversation. Likewise, called participant may act as a calling participant and establish one or more other real-time sessions with the calling participant or one or more other participants within the same logical conversation.

In this manner, multiple real-time sessions may be associated with a single logical conversation.

In general terms, the network is a communications link that facilitates the transfer of electronic content between, for example, the attached client computing system and server computing system. In one embodiment, the network includes the Internet. It will be appreciated that the network may be comprised of one or more other types of networks, such as a local area network, a wide area network, a point-to-point dial-up connection, and the like. In some embodiments, the network may include one or more server computing systems. In general terms, the server computing system may facilitate the establishment of the real-time session between the calling participant's client and the called participant's client. For example, the calling participant's client may send a request to establish a real-time session with a called participant to an appropriate server computing system, and the server computing system may forward the request to the called participant's client.

The client computer system may include one or more central processing units, memory, input devices (e.g., keyboard and pointing devices), output devices (e.g., display devices), and storage devices (e.g., disk drives). The memory and storage devices are computer-readable media that may contain instructions that implement the various techniques for associating one or more real-time sessions into one logical conversation, described herein. In addition, the data structures and message structures may be stored or transmitted via a data transmission medium, such as a signal on a communications link. Various communication links may be used, such as the Internet, a local area network, a wide area network, a point-to-point dial-up connection, a cell phone network, and so on. One of ordinary skill in the art will appreciate that the computer systems may be of various configurations having various components.

Embodiments of the described techniques may be implemented in various operating environments that include personal computers, server computers, computing devices, hand-held or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, kiosks, ATMs, and so on.

The various techniques for associating one or more real-time sessions into one logical conversation may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

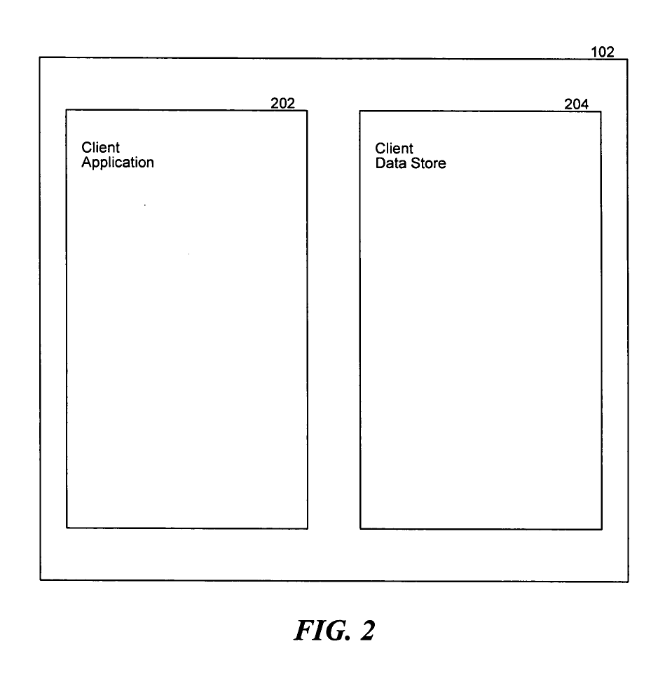

FIG. 2 is a block diagram illustrating selected components of a client, according to some embodiments. As depicted, client 102 comprises a client application 202 and a client data store 204. In general terms, the client application functions as an endpoint or user agent of its user. In some embodiments, the client application implements application-specific functionality that enables an instance of the client application to function as, by way of example, an instant messaging client, a voice over IP client, a teleconferencing client, a video conferencing client, an application sharing client, an audio/video client, any other client that establishes a real-time application-level session with another client application, or any combination thereof. For example, a user can use an instance of the client application to create a real-time instant messaging session (i.e., a real-time session in the instant messaging mode) with another user.

In some embodiments, the client application provides a user interface through which a user can initiate a logical conversation. For example, the user interface may provide a “button” or a “link” which the user can click to access a window for the logical conversation, and through which the user can request to establish a real-time session (i.e., the first real-time session belonging to the newly initiated logical conversation) in a desired mode with another user. Upon successfully creating the requested real-time session, the user may be provided a sub-window, a pane, or other suitable interface within the logical conversation window with which the user can participate in the created real-time session. For example, when the user uses the logical conversation window to create an instant messaging session, the user may be provided an instant messaging pane within the logical conversation window with which the user can instant message.

When the client application receives a request to establish a real-time session and the conversation identifier, the client application checks to determine if the logical conversation identified by the conversation identifier is currently running on the client. If the logical conversation is currently running on the client, the client application identifies the window for this logical conversation and provides an indication of the received request in the identified window. For example, the client application may display a link for the received real-time session in the identified window. A user may then click on the link to “accept” the request to establish the real-time session. In this case, the client application may display a sub-window or pane within the identified window with which the user can participate in the newly created real-time session. If there are no logical conversations running that are identified by the conversation identifier, the client application creates a new logical conversation and creates and displays a window for the newly created logical conversation. The client application may then display a link for the received real-time session in the newly created window.

In this manner, the client application provides a window for each logical conversation that is running on a client. The logical conversation window may include a sub-window or other suitable interface for each real-time session associated with or belonging to the logical conversation. The logical conversation window may also allow the user to establish additional real-time sessions to be included as part of the logical conversation. For example, the logical conversation window may provide a link or a list of links the user can use to create an additional real-time session or sessions. Upon the creation of the additional real-time session, a sub-window for the newly created real-time session may be provided within the logical conversation window. Thus, each logical conversation window provides the user a visual representation of the real-time sessions on the client that are associated with or that belong to the logical conversation.

In other embodiments, the client application may provide a window for each real-time session created on the client. In these embodiments, the window may provide an indication of the logical conversation to which the real-time session associated with the window belongs. For example, the indication of the logical conversation may be provided in the title bar of the window.

In general terms, the client data store facilitates the storage of the information that associates a real-time session created on the client to a logical conversation running on the client. For example, the client application stores the information and/or data that associates the real-time session to the logical conversation to which the real-time session belongs in the client data store. In some embodiments, the client data store is a database that includes records that indicate the association of the real-time sessions to their respective logical conversations, as well as other suitable information.

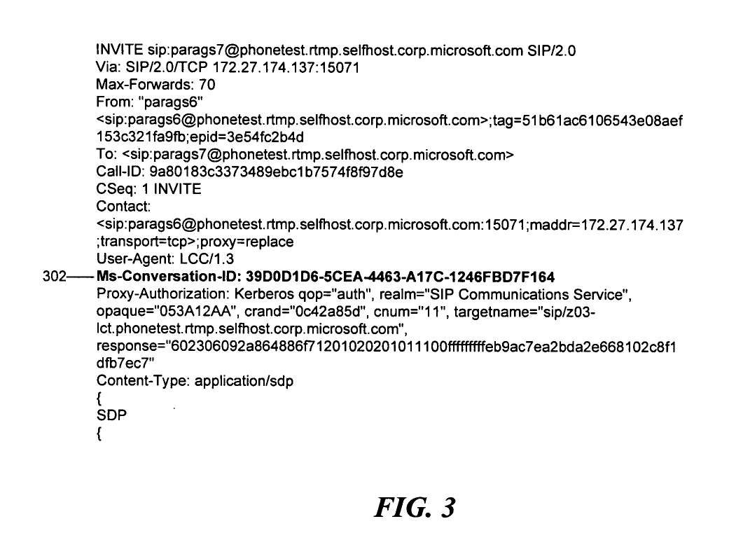

FIG. 3 illustrates an example SIP INVITE request that includes a conversation identifier, according to some embodiments. As illustrated, the SIP INVITE request includes a conversation identifier header 302 whose value or contents uniquely identify a logical conversation. For example, the value of the conversation identifier header is “39D0D1D6-5CEA-4463-A17C-1246FBD7F164” and, thus, the SIP INVITE request is an invitation from calling participant “parags6” to called participant “parags7” to create a real-time application session (i.e., a dialog) within the logical conversation identified by the string “39DOD1D6-5CEA-4463-A17C-1246FBD7F164.” In some embodiments, the value of the conversation identifier header is globally unique. In other embodiments, the conversation identifier may be transmitted between participants in a real-time session using any of a variety of well-known application-level protocols and/or signaling techniques.

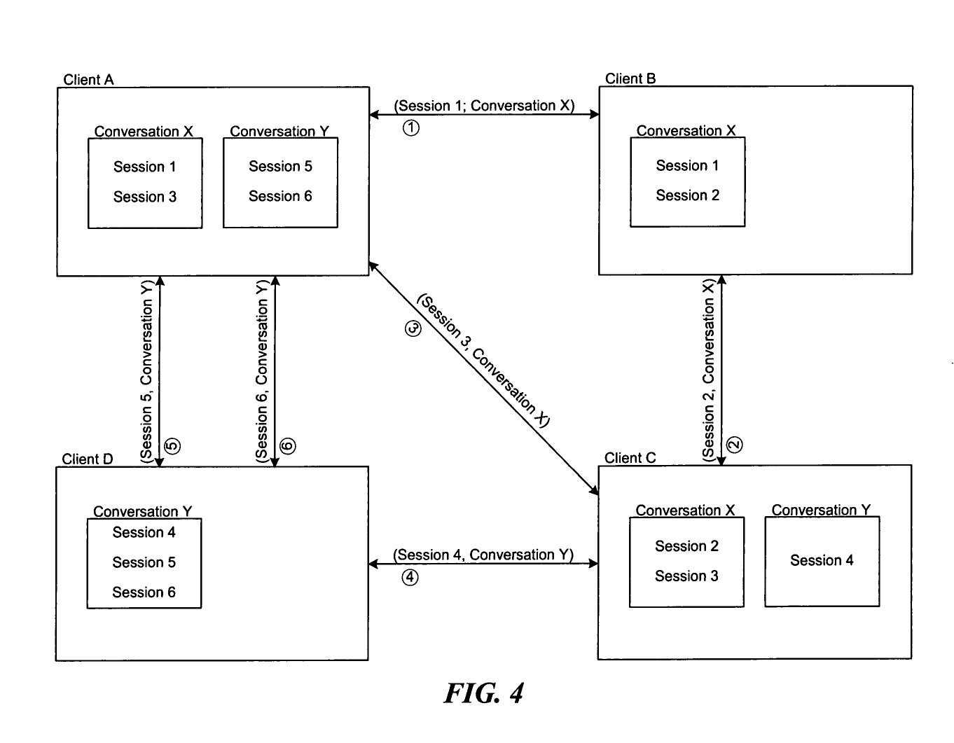

FIG. 4 is a diagram illustrating interactions between clients in sharing a conversation identifier across multiple real-time sessions without a centralized control, according to some embodiments. By way of example, a user at client A may initiate a logical conversation by requesting an instant messaging session with a user at client B. In establishing the requested instant messaging session 1, client A generates a conversation identifier, for example, “Conversation X” that uniquely identifies the new logical conversation, and sends client B the conversation identifier with the request to create the instant messaging session. Upon creating the instant messaging session, for example, identified as “Session 1,” client A and client B each associates “Session 1” to “Conversation X.” For example, client A and client B may each create a table or a record for each logical conversation that is created on the client, and identify the real-time sessions belonging to an appropriate logical conversation in its corresponding table or record, or other suitable data structure.

The user at client B may then request an instant messaging session with a user at client C as part of the existing logical conversation “Conversation X.” In establishing the requested instant messaging session 2, client B retrieves the conversation identifier “Conversation X,” and sends client C the conversation identifier with the request to create the instant messaging session. Upon creating the instant messaging session, for example, identified as “Session 2,” client B and client C each associates “Session 2” to “Conversation X.” For example, client B may include an entry for “Session 2” in the table it previously created for “Conversation X.” In this manner, “Session 1” and “Session 2” are associated with the same logical conversation “Conversation X” on client B. Client C may create a table for “Conversation X” and include an entry for “Session 2” in this table.

The user at client C may then request an application sharing session with the user at client A as part of the existing logical conversation “Conversation X.” In establishing the requested application sharing session 3, client C retrieves the conversation identifier “Conversation X,” and sends client A the conversation identifier with the request to create the application sharing session. Upon creating the application sharing session, for example, identified as “Session 3,” client B and client C each associates “Session 3” to “Conversation X” by, for example, including an entry for “Session 3” in the table it previously created for “Conversation X.”

The user at client C may then initiate a new logical conversation by requesting an audio/video session with a user at client D. In establishing the requested audio/video session 4, client C generates a conversation identifier, for example, “Conversation Y” that uniquely identifies the new logical conversation, and sends client D the conversation identifier with the request to create the audio/video session. Upon creating the audio/video session, for example, identified as “Session 4,” client C and client D each associates “Session 4” to “Conversation Y” by, for example, creating a table for “Conversation Y” and including an entry for “Session 4” in the table created for “Conversation Y.”

The user at client D may then request an instant messaging session with the user at client A as part of the existing logical conversation “Conversation Y.” In establishing the requested instant messaging session 5, client D retrieves the conversation identifier “Conversation Y,” and sends client A the conversation identifier with the request to create the instant messaging session. Upon creating the instant messaging session, for example, identified as “Session 5,” client D and client A each associates “Session 5” to “Conversation Y.” For example, client D may include an entry for “Session 5” in the table it previously created for “Conversation Y.” Client A may create a table for “Conversation Y” and include an entry for “Session 5” in this table.

The user at client A may then request an application sharing session with the user at client D as part of the existing logical conversation “Conversation Y.” In establishing the requested application sharing session 6, client A retrieves the conversation identifier “Conversation Y,” and sends client D the conversation identifier with the request to create the application sharing session. Upon creating the application sharing session, for example, identified as “Session 6,” client A and client D each associates “Session 6” to “Conversation Y” by, for example, including an entry for “Session 6” in the table it previously created for “Conversation Y.”

Thus, multiple real-time sessions may be associated with a single logical conversation on a client. Moreover, since each of the real-time sessions may be any of a variety of modes, multiple modes may be associated with the single logical conversation on the client.

In some embodiments, upon termination of a real-time session, the identifier of the terminated real-time session is removed from the table or record corresponding to the logical conversation to which the terminated real-time session belonged. In some embodiments, when all real-time sessions belonging to a logical conversation are terminated, table or record corresponding to the logical conversation is removed (e.g., deleted).

In some embodiments, the initiator of a logical conversation may specify policies that are to be applied to the logical conversation. For example, the policies may specify information such as, who is allowed to join the logical conversation, what modes are allowed in the logical conversation, what times are permitted for conducting the logical conversation, etc. The specified policies may be passed to the clients along with the conversation identifier.

In some embodiments, a participant in a logical conversation may query one or more other participants in the logical conversation to determine information regarding the logical conversation. For example, a participant A may be conducting an instant messaging session with a participant B as part of a logical conversation, and may query participant B for information regarding other sessions that participant B is participating in. In this manner, participant A can create a roster of active sessions in the logical conversation. Similarly, participant A can create a roster of participants participating in a logical conversation by, for example, querying participant B for information regarding the other participants with whom participant B is actively conducting sessions with.

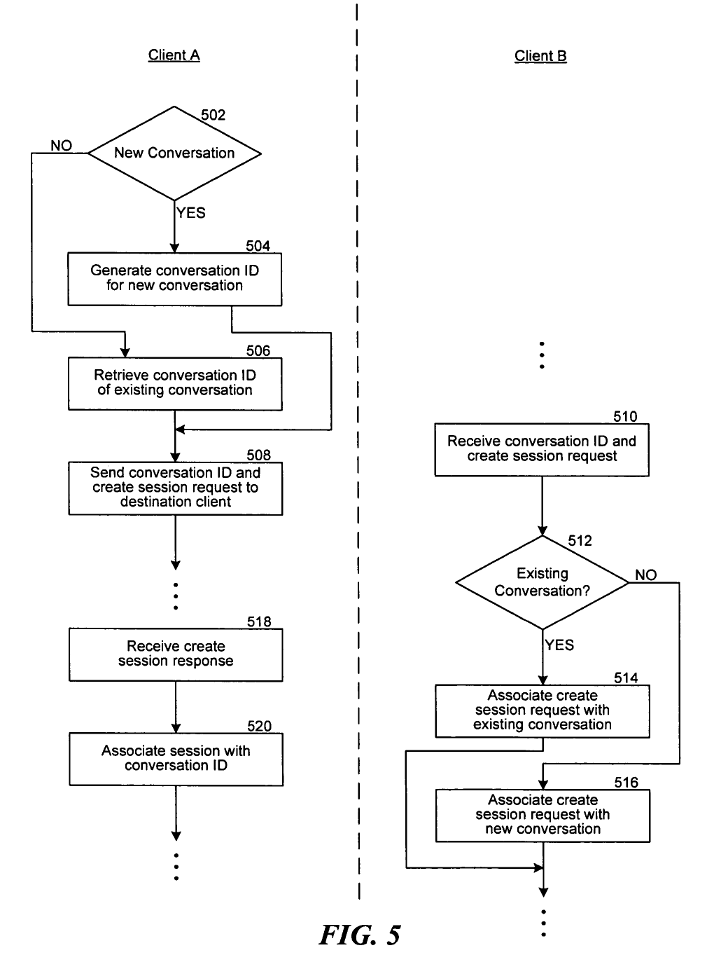

FIG. 5 is a flow diagram illustrating the sending of a conversation identifier between two clients, according to some embodiments. By way of example, a calling participant at a client A may use an instance of a client application to submit a request to create an application sharing session with a called participant at a client B. In block 502, the client application on client A checks to determine whether the request is for a new logical conversation on client A. Stated another way, the client application checks to determine if the request to create the application sharing session is the first session that is signaled in a logical conversation.

If the request is for a new logical conversation, then, in block 504, the client application generates a new conversation identifier that uniquely identifies the new logical conversation. The client application may use any of a variety of well-known techniques to generate a unique identifier. Otherwise, if the request is not for a new logical conversation, but is a part of a logical conversation that currently exists on client A, then, in block 508, the client application retrieves the conversation identifier of the existing logical conversation. In block 508, the client application sends the conversation identifier (i.e., either the newly generated conversation identifier, or the retrieved conversation identifier) and the request to create the application sharing session to client B.

In block 510, an instance of a client application on client B receives the conversation identifier and the request to create the application sharing session from client A. In block 512, the client application checks to determine if the received conversation identifier matches any of the logical conversations that are active on client B. If the received conversation identifier matches a logical conversation that is currently active, then, in block 514, the client application associates the request to create the application sharing session with the currently existing logical conversation that is identified by the conversation identifier. Conversely, if the received conversation identifier does not match any of the logical conversation that are currently active, then, in block 516, the client application creates a new logical conversation on client B, identifies the newly created logical conversation using the received conversation identifier, and associates the request to create the application sharing session with the newly created logical conversation. The client application may then provide the called participant an indication of the received request to create the application sharing session. If the called participant accepts the request, the client application sends client A an appropriate response message creating the application sharing session, and associates the application sharing session to the logical conversation (i.e., either the existing logical conversation identified by the conversation identifier, or the newly created logical conversation).

Subsequently, in block 518, the client application on client A receives the response message to create the application sharing session. In block 520, the client application associates the application sharing session with the logical conversation identified by the conversation identifier.

One skilled in the art will appreciate that, for this and other processes and methods disclosed herein, the functions performed in the processes and methods may be implemented in differing order. Furthermore, the outlined steps are only exemplary, and some of the steps may be optional, combined with fewer steps, or expanded into additional steps.

Conversation Threads

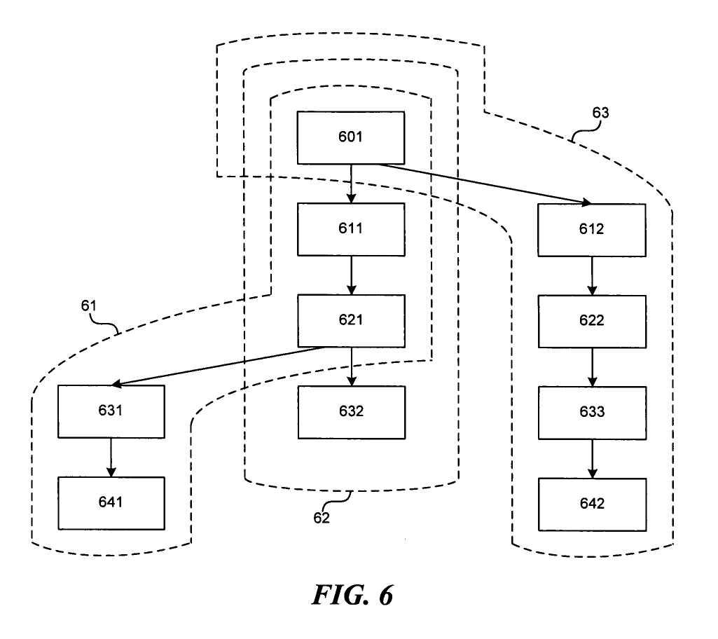

FIG. 6 is a diagram illustrating a plurality of conversation threads, according to some embodiments. As depicted, a conversation thread 61 is comprised of the sequence of conversation thread instances 601, 611, 621, 631 and 641, a conversation thread 62 is comprises of the sequence of conversation thread instances 601, 611, 621 and 632, and a conversation thread 63 is comprised of the sequence of conversation thread instances 601, 612, 622, 633 and 642. The three conversation threads each originate from the same conversation thread instance—i.e., conversation thread instance 601, which is considered a “root” conversation thread instance for these three conversation threads—and define a sequence of conversations between conversation participants.

The root conversation thread instance indicates the first conversation that took place, and each of the three conversation threads is a series of continuations of the first conversation. For example, conversation thread instance 641 is a continuation of conversation thread instance 631, which is a continuation of conversation thread instance 621, which is a continuation of conversation thread instance 611, which is a continuation of the root conversation thread instance 601. Likewise, conversation thread instance 632 is a continuation of conversation thread instance 621, which is a continuation of conversation thread instance 611, which is a continuation of the root conversation thread instance 601, and conversation thread instance 642 is a continuation of conversation thread instance 633, which is a continuation of conversation thread instance 622, which is a continuation of conversation thread instance 612, which is a continuation of the root conversation thread instance 601.

In some embodiments, each conversation thread instance contains metadata of the entire conversation thread to which the conversation thread instance belongs up to that time. The metadata describes the conversation thread up to an instance in time. The metadata tracks the life-cycle of the conversation thread, and allows the retrieval of preceding conversation thread instances of a conversation thread from any conversation thread instance. Stated another way, the metadata associated with a conversation thread instance provides the conversation thread instance with knowledge of its predecessor conversation thread instance from which it continues from in the conversation thread. The root conversation thread instance, since it constructed the conversation thread, does not have a predecessor conversation thread instance. As such, each conversation thread instance describes the history of the conversation up to that time. For example, in conversation thread 61, conversation thread instance 631 includes metadata that provides knowledge of conversation thread instance 621 and, thus, knowledge of the other preceding conversation thread instances 611 and 601 in the conversation thread. Thus, a participant in a conversation having knowledge of conversation thread instance 631 is able to use the metadata to retrieve any of the preceding conversation thread instances 621, 611 and 601.

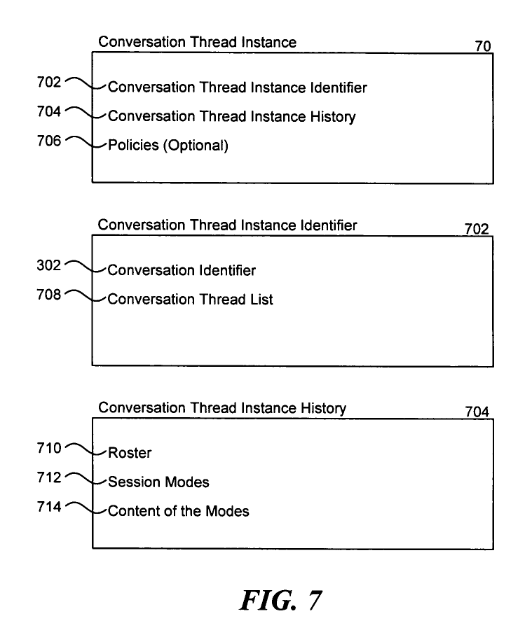

FIG. 7 is a block diagram illustrating metadata associated with a conversation thread instance, according to some embodiments. As depicted, a conversation thread instance 70 is associated with a conversation thread instance identifier 702, a conversation thread instance history 704 and, optionally, policies 706. The conversation thread instance identifier uniquely identifies the conversation thread instance. In some embodiments, the conversation thread instance identifier is a combination of the conversation identifier 302 and a conversation thread list 708. As discussed above, the conversation identifier uniquely identifies the conversation to which the conversation thread instance belongs. The conversation thread list identifies the participant who started the conversation thread (i.e., the conversation thread originator) and a timestamp that indicates the time the conversation thread was constructed, and a list of each participant that continued the conversation thread up to the present conversation thread instance, and a corresponding timestamp for each continuation of the conversation thread. The conversation thread instances that originate from the same root conversation thread instance are threads in the same conversation and thus, maintain the same conversation identifier. The conversation thread list may be used to identify the participants who either constructed the conversation thread or continued the conversation thread, and the sequence in which the participants continued the conversation thread. In some embodiments, the conversation thread instance identifier may be maintained by two SIP headers (i.e., one SIP header for the conversation identifier, and one SIP header for the conversation thread list) whose values indicate the conversation identifier and the conversation thread list. The participants may be identified in the conversation thread list by their respective SIP URIs.

The conversation thread instance history describes the history of the conversation thread up to the conversation thread instance. In some embodiments, the conversation thread instance history comprises a roster 710, session modes 712 and a content of the modes 714. The roster identifies the participants who participated or were involved in the conversation thread. The roster not only identifies the participants who started the conversation thread or continued the conversation thread, but also the other participants who were involved in the conversation thread.

The session modes identify the types of sessions (i.e., conversation modes) that were conducted in the conversation thread. For example, the session modes may indicate that there were three instant messaging, two application sharing, and one video sessions that took place between various participants in the conversation thread. The content of the modes may be a record of the content that was exchanged during the various conversation modes. Continuing the example, for the aforementioned session modes, the content of the modes may be a record of the content that was exchanged during each of the three instant messaging, two application sharing, and one video sessions that took place between various participants in the conversation thread.

The policies, if present and supported, indicate the policies to apply to the conversation thread instance and/or the conversation thread instance history. The policies may be defined or set by the participant that constructed the conversation thread, an owner of content that was exchanged or shared in the conversation thread, a conversation or communications administrator, and/or any user having privileges to set the policies. For example, the policies may specify that the content of an instant messaging session is not to be provided to certain users or certain groups of users. As another example, the policies may specify that certain users or groups of users are not to be included in the conversation thread. As still another example, the policies may specify that only user having at least a minimum set or level of privileges are to be provided some or all of the content exchanged in the conversation thread.

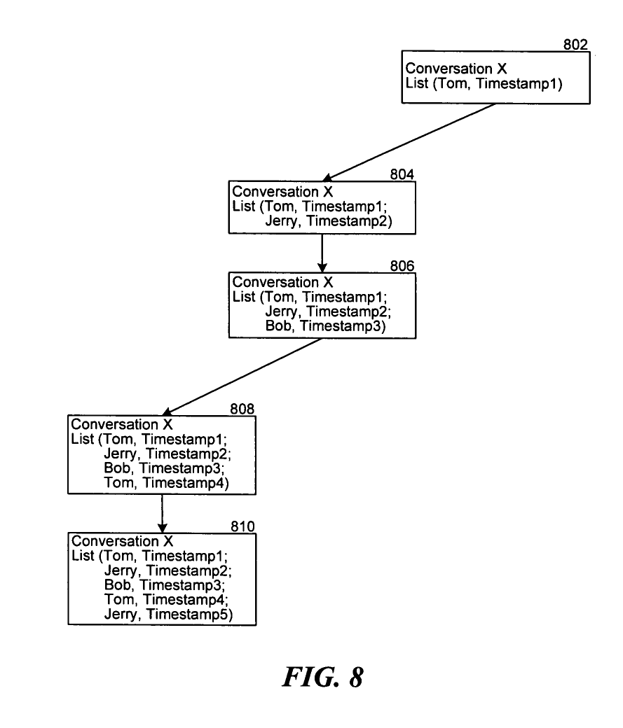

FIG. 8 is a diagram illustrating the generation of the conversation thread list of an example conversation thread, according to some embodiments. As depicted, the conversation thread is comprised of a root conversation thread instance 802 followed in sequence by conversation thread instances 804, 806, 808 and 810. By way of example, the conversation thread list associated with the root conversation thread instance 802 for the conversation identified as “Conversation X” indicates that “Tom” created the conversation thread at a time “Timestamp1.” The conversation thread list identifies “Tom” as the originator of the conversation thread, and “Timestamp1” as the time the conversation thread was originated.

Subsequently, “Jerry” continues the conversation thread from the root conversation thread instance 802 at a time “Timestamp2,” as reflected in the conversation thread list associated with conversation thread instance 804. The conversation thread list associated with the root conversation thread instance 802 (i.e., the “parent” or preceding conversation thread instance) is appended to indicate that “Jerry” continued the conversation thread from conversation thread instance 802 at a time “Timestamp2.” Appending the continuation information to the conversation thread list allows for the identification of its associated conversation thread instance as well as the identification of any preceding conversation thread instance. For example, the conversation thread list associated with conversation thread instance 804 allows for the identification of its preceding root conversation thread instance 802.

Subsequently, “Bob” continues the conversation thread from conversation thread instance 804 at a time “Timestamp3,” as reflected in the conversation thread list associated with conversation thread instance 806. The conversation thread list associated with conversation thread instance 804 is appended to indicate that “Bob” continued the conversation thread from conversation thread instance 804 at a time “Timestamp3.” Thus, the conversation thread list associated with conversation thread instance 806 may be used to identify its preceding conversation thread instance 804 and its preceding root conversation thread instance 802.

Subsequently, “Tom” continues the conversation thread from conversation thread instance 806 at a time “Timestamp4,” as reflected in the conversation thread list associated with conversation thread instance 808. The conversation thread list associated with conversation thread instance 806 is appended to indicate that “Tom” continued the conversation thread from conversation thread instance 806 at a time “Timestamp4.” Thus, the conversation thread list associated with conversation thread instance 808 may be used to identify its preceding conversation thread instance 806, its preceding conversation thread instance 804 and its preceding root conversation thread instance 802.

Subsequently, “Jerry” continues the conversation thread from conversation thread instance 808 at a time “Timestamp5,” as reflected in the conversation thread list associated with conversation thread instance 810. The conversation thread list associated with conversation thread instance 808 is appended to indicate that “Jerry” continued the conversation thread from conversation thread instance 808 at a time “Timestamp5.” Thus, the conversation thread list associated with conversation thread instance 810 may be used to identify its preceding conversation thread instance 808, its preceding conversation thread instance 806, its preceding conversation thread instance 804 and its preceding root conversation thread instance 802.

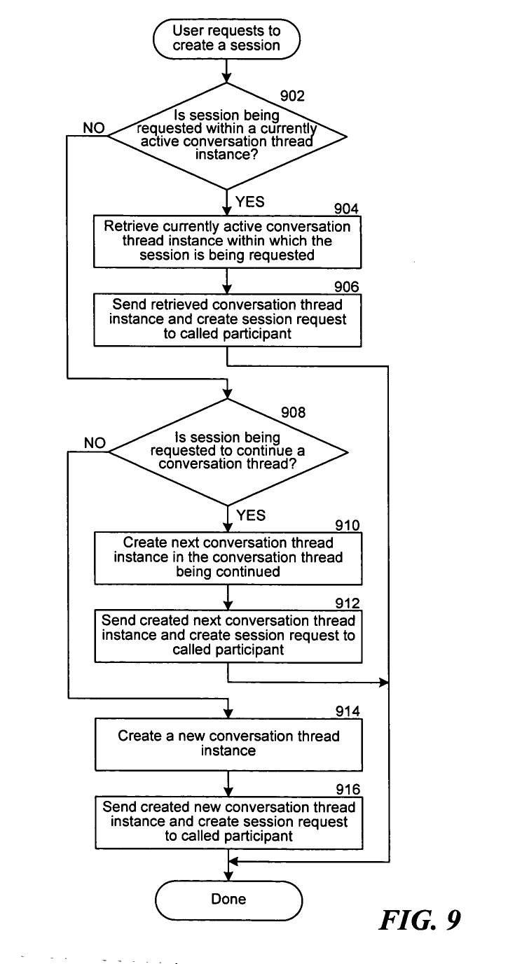

FIG. 9 is a flow diagram illustrating the processing of a client application when a user requests to create a session, according to some embodiments. By way of example, a calling participant at a client A may use an instance of a client application to submit a request to create an instant messaging session with a called participant at a client B. In block 902, the client application on client A checks to determine whether the session is being requested within a currently active conversation thread instance client A. Stated another way, the client application checks to determine if the request to create the instant messaging session is a part of an ongoing conversation (i.e., as part of an active conversation thread instance).

If the session is being requested as part of an active conversation thread instance on client A, then, in block 904, the client application retrieves the currently active conversation thread instance within which the session is being requested. In block 906, the client application sends the retrieved conversation thread instance and the request to create the instant messaging session to client B. In some embodiments, the client application sends the conversation thread instance identifier and the conversation thread instance history of the retrieved conversation thread instance with the request to create the instant messaging session to client B. In some embodiments, the client application may filter the conversation thread instance history according to the policies that are in effect for the retrieved conversation thread instance prior to sending the conversation thread instance history.

If, in block 902, the client application on client A determines that the session is not being requested as part of an active conversation thread instance on client A, then, in block 908, the client application checks to determine whether the session is being requested to continue a conversation thread. If the session is being requested to continue a conversation thread, then, in block 910, the client application creates a next conversation thread instance in the conversation thread that is being continued.

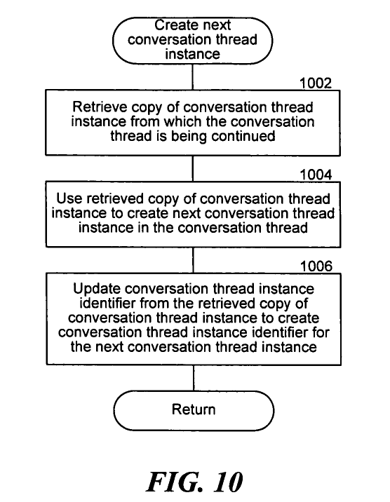

FIG. 10 is a flow diagram illustrating the processing of a client application to create a next conversation thread instance, according to some embodiments. In block 1002, the client application retrieves a copy of the conversation thread instance from which the conversation thread is being continued. The calling participant would have specified the conversation thread instance to continue. In block 1004, the client application uses the retrieved copy of the conversation thread instance to create the next conversation thread instance in the conversation thread. The created conversation thread instance (i.e., the next conversation thread instance) is the conversation thread instance that sequentially follows the conversation thread instance in the conversation thread from which the conversation thread is being continued. In block 1006, the client application updates the conversation thread instance identifier from the retrieved copy of the conversation thread instance to create a conversation thread instance identifier for the next conversation thread instance. The conversation thread instance history from the retrieved copy of the conversation thread instance becomes the conversation thread instance history of the next conversation thread instance.

In some embodiments, the client application creates the conversation thread instance identifier for the next conversation thread instance by appending to the conversation thread list the identity of the participant who is continuing the conversation thread and the time the conversation thread is being continued. The client application may also update the conversation thread instance history. For example, the client application may update the roster component of the conversation thread instance history to identify the participants of the instant messaging session, and indicate the requested instant messaging session in the session modes component of the conversation thread instance history. In some embodiments, during the course of the instant messaging session and/or subsequent to completion of the instant messaging session, the client application may store the content of the instant messaging session as part of the conversation thread instance history.

Referring again to FIG. 9, in block 912, the client application sends the next conversation thread instance and the request to create the instant messaging session to client B. Otherwise, if, in block 908, the client application on client A determines that the session is not being requested to continue a conversation thread, then, in block 914, the client application creates a new conversation thread instance for the requested session. Stated another way, the client application creates a new conversation and, thus, a new conversation thread, for the requested instant messaging session. In block 916, the client application sends the new conversation thread instance and the request to create the instant messaging session to client B.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A computer-readable medium whose contents cause a computing system to manage continuity of a conversation thread at a client by:
detecting that the client is constructing the conversation thread; and
upon detecting that the client is constructing the conversation thread,
creating a first conversation thread instance for the conversation thread, the first conversation thread instance comprising a conversation thread instance identifier that uniquely identifies the first conversation thread instance, wherein the conversation thread instance identifier may be used to obtain information regarding the conversation thread up to the conversation thread instance identified by the conversation thread instance identifier; and
passing the first conversation thread instance to a called participant who is participating in the conversation thread,
wherein the conversation thread comprises at least one real-time session.

2. The computer-readable medium of claim 1, wherein the conversation thread instance identifier includes a conversation thread instance identifier of an immediately preceding conversation thread instance in the conversation thread.

3. The computer-readable medium of claim 1, wherein the conversation thread instance identifier comprises a conversation identifier that uniquely identifies a conversation to which the conversation thread belongs.

4. The computer-readable medium of claim 1, wherein the conversation thread instance identifier comprises an indication of a participant constructing the conversation thread and a time that the conversation thread is being constructed.

5. The computer-readable medium of claim 1, wherein the first conversation thread instance has associated with it a history of the conversation thread up to the first conversation thread instance.

6. The computer-readable medium of claim 5, wherein the history of the conversation thread comprises information regarding the participants who have participated in the conversation thread.

7. The computer-readable medium of claim 5, wherein the history of the conversation thread comprises information regarding the modes of the real-time sessions that occurred during the conversation thread.

8. The computer-readable medium of claim 5, wherein the history of the conversation thread comprises content of at least one real-time session that occurred during the conversation thread.

9. The computer-readable medium of claim 1 further comprising persistently storing the first conversation thread instance on the client.

10. The computer-readable medium of claim 1 further comprising updating the first conversation thread instance.

11. The computer-readable medium of claim 1 further comprising:
detecting that the client is continuing the conversation thread; and
upon detecting that the client is continuing the conversation thread,
retrieving a copy of a conversation thread instance from which the conversation thread is being continued;
creating a continuing conversation thread instance for the conversation thread by updating the conversation thread instance identifier of the retrieved conversation thread instance, the updated conversation thread instance identifier uniquely identifying the continuing conversation thread instance, wherein the updated conversation thread instance identifier may be used to identify the retrieved conversation thread instance; and
passing the continuing conversation thread instance to a called participant who is participating in the continued conversation thread.

12. The computer-readable medium of claim 11, wherein the updating the conversation thread instance identifier includes appending the conversation thread instance identifier with an indication of a participant continuing the conversation thread and a time that the conversation thread is being continued.

13. A computer-implemented method for continuing a conversation thread comprising:
detecting that a conversation thread is being continued from an existing conversation thread instance, the existing conversation thread instance being identified by a conversation thread instance identifier that uniquely identifies the existing conversation thread instance, the conversation thread instance identifier suitable for use in identifying the preceding conversation thread instances in the conversation thread up to a root conversation thread instance of the conversation thread; and
after detecting that the conversation thread is being continued from the existing conversation thread instance,
creating a new conversation thread instance;
identifying the new conversation thread instance using a new conversation thread instance identifier that uniquely identifies the new conversation thread instance, the new conversation thread instance identifier including the existing conversation thread instance identifier; and
passing the new conversation thread instance identifier to a called participant who is participating in the continued conversation thread.

14. The method of claim 13, wherein the new conversation thread instance identifier is the existing conversation thread identifier appended with an indication of a participant who is continuing the conversation thread from the existing conversation thread instance and an indication of the time the conversation thread is being continued.

15. The method of claim 13, wherein the new conversation thread instance identifier may be used to retrieve past information regarding the conversation thread.

16. The method of claim 15, wherein the past information regarding the conversation thread is filtered.

17. The method of claim 13, wherein the called participant may pass the new conversation thread instance identifier to a third participant who is participating in the continued conversation thread.

18. One or more data signals that collectively convey a data structure, the data structure comprising a conversation identifier that uniquely identifies a conversation and a list of at least one participant that either created a conversation thread in the conversation or continued the conversation thread in the conversation and a corresponding time when the participant either created or continued the conversation thread,
such that the contents of the data structure may be used to obtain the past content of the conversation thread.

19. The data signals of claim 18, wherein the data structure comprises information regarding participants who participated in the conversation thread.

20. The data signals of claim 18, wherein the data structure comprises policy information.
